(19) United States
(12) Patent Application Publication
(10) Pub. No.: US 2010/0106570 A1
(43) Pub. Date: Apr. 29, 2010

(54) SYSTEMS AND METHODS FOR ENROLLMENT AND PARTICIPATION IN A LOYALTY PROGRAM

(76) Inventors: Cristian Radu, Beauvechain (BE); Fikret Ates, Namur (BE); Jan Landequist, Bruxelles (BE); Ainsley Charles Ward, Tervuren (BE); Steven Van Sweevelt, Grimbergen (BE); David Grossman, Brooklyn, NY (US); Aziz Koufkouf, Brussels (BE)

Correspondence Address: BUCKLEY, MASCHOFF & TALWALKAR LLC, 50 LOCUST AVENUE, NEW CANAAN, CT, 06840, US

(21) Appl. No.: 12/259,466

(22) Filed: Oct. 28, 2008

(51) Int. Cl. G06Q 30/00; G07G 1/14; G06Q 20/00

(52) U.S. Cl. 705/14.3; 705/14.36

(57) ABSTRACT

According to some embodiments, systems, methods, apparatus, computer program code and means are provided for enrolling payment cardholders in loyalty programs and processing loyalty transactions. Some embodiments include receiving, from a consumer associated with a payment device, loyalty program enrollment information and a payment device identifier, the loyalty program enrollment information including a loyalty program identifier, and providing the loyalty program enrollment information and the payment device identifier to at least one of an issuer of the payment device and an agent of the issuer. The loyalty program identifier is caused to be stored in a memory of said payment device.

### FIELD

The present invention relates to loyalty programs. In particular, the present invention relates to systems and methods for enrollment and participation in a loyalty program.

### BACKGROUND

Retail loyalty programs are in widespread use throughout the world. In a typical retail loyalty program, a consumer enrolls, registers or otherwise signs up for participation, and is then provided with a plastic “loyalty card” which has a customer identification number associated with it. The loyalty card may simply have the customer identification number printed on it, or it may have it stored in a magnetic stripe of the card. The customer then presents the loyalty card (or the customer identification number) when shopping at the retailer to accrue loyalty points or receive other benefits from shopping at the retailer.

Consumers who frequent more than one retailer tend to accumulate these loyalty cards. A survey carried out in 2005 in Great Britain found that there were over 154 million loyalty cards in circulation, and over 56% of consumers carried more than three loyalty cards. Over 20% of consumers carried more than five loyalty cards in their wallet or purse. As consumers collect more of these cards, they tend to lose track of them and the marketing benefits of participation are diminished. The same survey carried out in 2005 in Great Britain showed that there was over 958 million pound sterling of unclaimed benefits held on these loyalty cards.

It would be desirable to provide systems and methods that would allow consumers to participate in more than one loyalty program without the need to carry more than one loyalty card. It would further be desirable to provide systems and methods that allow easy and convenient registration and participation in these loyalty programs.

### BRIEF DESCRIPTION OF THE DRAWINGS

FIG. 1 is a block diagram representation of a system that may be provided according to some embodiments.

FIG. 2 is a flow chart that illustrates a loyalty program enrollment method that may be performed according to some embodiments.

FIGS. 3A and 3B are flow charts that illustrate further loyalty program enrollment methods that may be performed according to some embodiments.

FIG. 4 is a flow chart that illustrates a loyalty program script loading process that may be performed according to some embodiments.

FIG. 5 is a flow chart that illustrates a loyalty program transaction that may be performed according to some embodiments.

FIG. 6 is a block diagram of an integrated circuit that may be used in a payment device used according to some embodiments.

FIG. 7 is a block diagram of a merchant device according to some embodiments.

FIG. 8 is a portion of a tabular representation of an enrollment file according to some embodiments.

### DETAILED DESCRIPTION

Embodiments of the present invention provide improved methods and systems for enrolling consumers in retail loyalty programs. Pursuant to some embodiments, consumers register to participate in loyalty programs during transactions at merchants. The merchant assigns the consumer a loyalty identifier, and the loyalty identifier is stored on a payment card of the consumer. A number of different merchant loyalty identifiers may be stored on each consumer's payment card. Once a loyalty identifier is stored on a consumer's payment card, the loyalty identifier may be automatically presented during future transactions by the consumer at merchant retail locations. The result is a system which provides a number of desirable advantages to consumers, retailers, payment card issuers, and payment networks. For example, consumers no longer need to carry or keep track of different loyalty cards for different retailers. Retailers are able to encourage and promote greater adoption and use of their existing loyalty programs without changing their existing infrastructure. Further, retailers enjoy cost savings by eliminating or reducing the need to produce, distribute and maintain plastic loyalty cards.

With these and other advantages and features of the invention that will become hereinafter apparent, the invention may be more clearly understood by reference to the following detailed description of the invention, the appended claims, and the drawings attached herein.

A number of terms are used throughout the disclosure. These terms are used for convenience and ease of exposition. For example, some embodiments of the present invention are associated with a “consumer” who uses a payment account which may be accessed using a “payment device”. As used herein, the term “consumer” might refer to, for example, a person (or entity) who executes transactions with merchants. Moreover, the term “payment account” might refer to, for example, any financial account used by the consumer to perform transactions, including, for example, a credit account, a deposit account, a pre-paid or stored value account or the like.

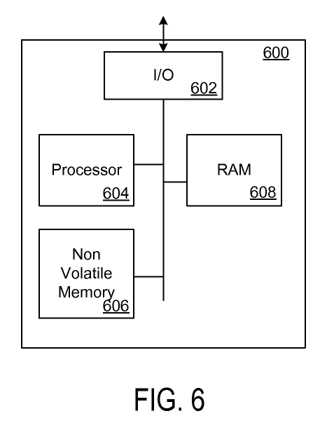

The term “payment device” refers to a device used to permit or control access to a payment account. A payment device may be configured to interact with contact or contactless readers and may have an integrated circuit chip (ICC) mounted in or on a body of the payment device. The payment device may be formed in a traditional plastic credit card shaped body, or it may be mounted in or on a body of another device (e.g., such as a mobile telephone, a hand-held computer, a key fob, or the like). In some embodiments, the ICC has a memory portion which stores transaction data such as, for example, a consumer's primary account number (or “PAN”) which is used to access the consumer's payment account. Further aspects of payment devices which may be used pursuant to some embodiments will be described further below in conjunction with FIG. 6.

The term “loyalty program” is used to refer to a program, typically operated by a retailer or merchant, that rewards customers for continuing to purchase goods or services at the retailer. A number of different types of loyalty programs are supported by embodiments of the present invention. In general, embodiments of the present invention may be used with any loyalty program in which a customer is assigned a “loyalty identifier” (or “loyalty ID”) and in which the customer receives some benefit for presenting the loyalty identifier while shopping at the retailer. Pursuant to some embodiments, a consumer may participate in more than one loyalty program and may be assigned more than one loyalty identifier.

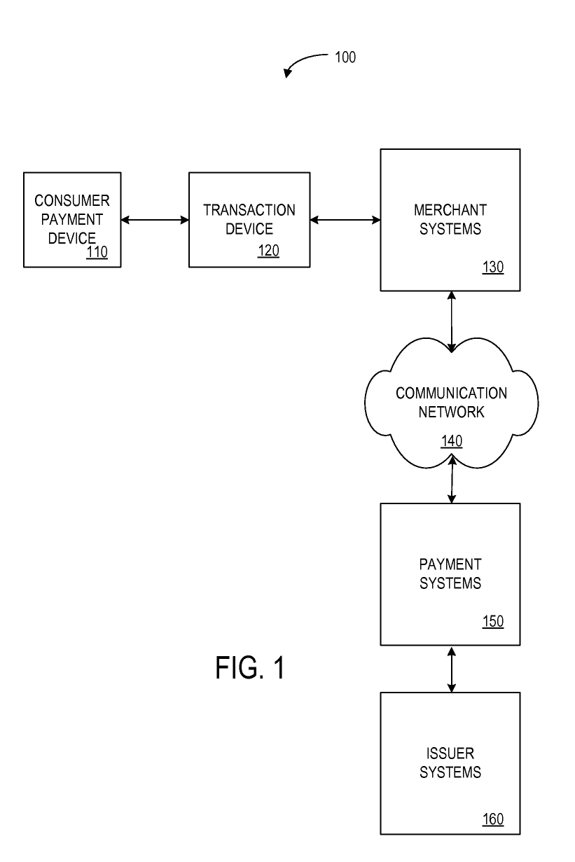

Features of some embodiments will now be described by first referring to FIG. 1, where a block diagram representation of a system 100 is shown that may be used to enroll customers in loyalty programs. As will be described further below, the system 100 may also be used to load or install loyalty identification information onto customer devices as well as to process payment transactions.

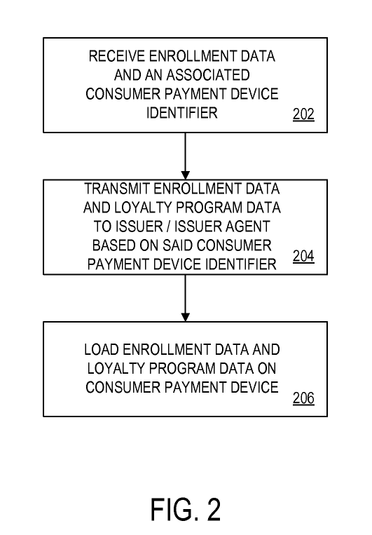

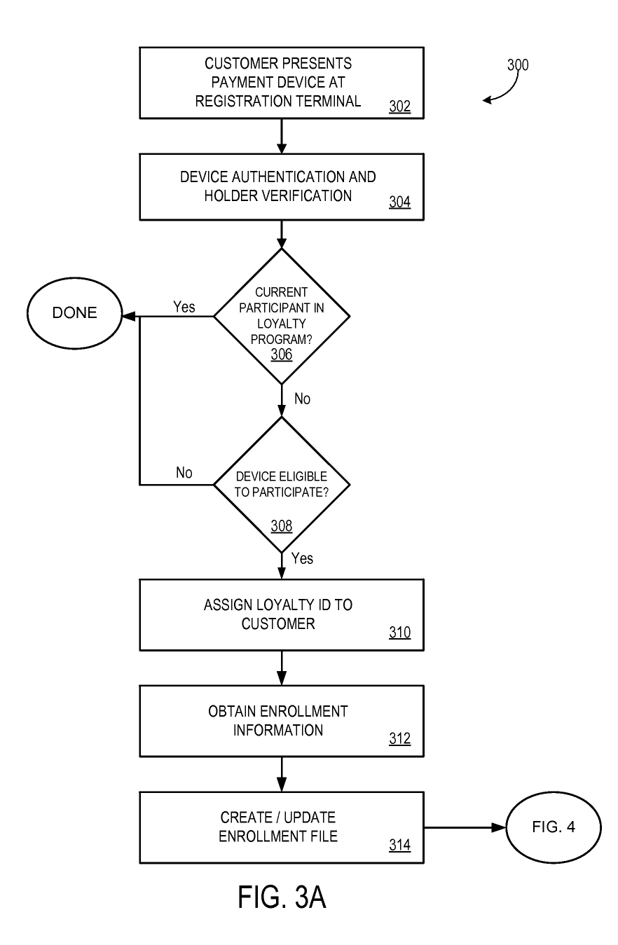

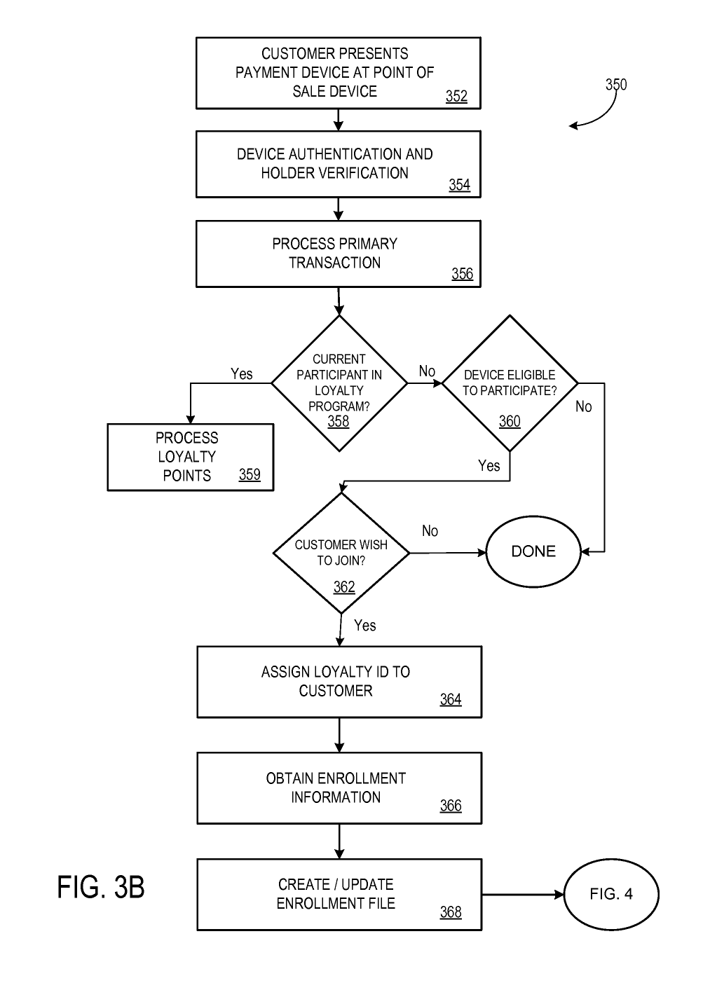

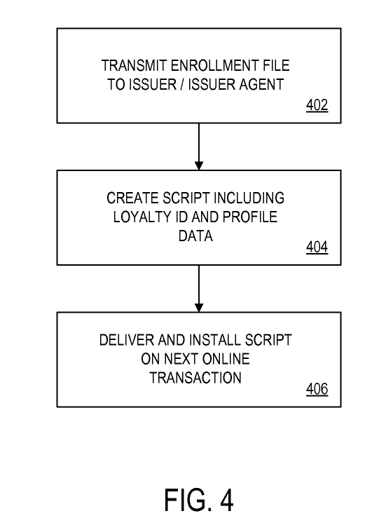

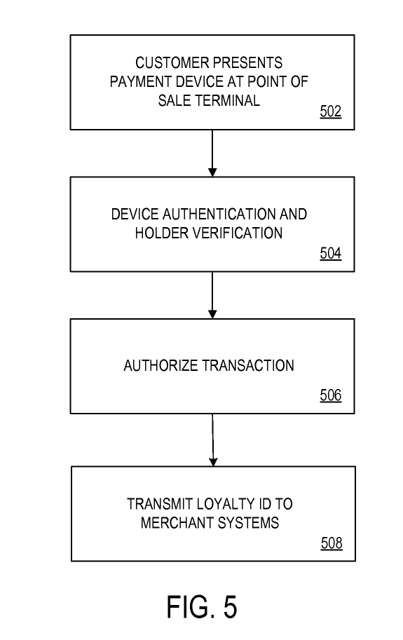

The system 100 includes a number of entities or devices interacting to process transactions pursuant to some embodiments, including loyalty program enrollment transactions (described below in conjunction with FIGS. 2-3), loyalty script transactions (described below in conjunction with FIG. 4), and loyalty transactions (described below in conjunction with FIG. 5).

The system 100 includes a number of entities or devices, including a consumer payment device 110. Pursuant to some embodiments, consumer payment device 110 is a “smart” payment device including an integrated circuit (“IC”) chip with a processor and memory. An example of an IC chip that may be used in the consumer payment device 110 that may and used in conjunction with embodiments of the present invention is shown and described below in conjunction with a description of FIG. 6.

In general, embodiments of the present invention involve the use of payment devices that are capable of storing data, including data identifying a payment account associated with the device, as well as data associated with one ore more loyalty programs in which the consumer participates pursuant to the present invention. In some embodiments, the consumer payment device 110 is configured to operate in accordance with one or more standards, such as the EMV payment standard promulgated by EMVCo, LLC (and available at www.emvco.com). For example, the payment device may store and retrieve data as specified by the EMV standards and may also interact with merchant terminals and payment processing networks pursuant to the EMV standards. While the following description will be provided in the context of the EMV standards, those skilled in the art will appreciate that payment devices configured to operate pursuant to other standards will also benefit from features of the present invention.

The consumer payment device 110 might communicate with, for example, one or more transaction devices 120, such as point of sale (“POS”) terminals or other merchant terminals located at various merchant and/or retail establishments. The transaction devices 120 might include magnetic stripe card readers, proximity coupling devices and/or other peripheral devices which allow the terminals to communicate with the consumer payment device 110 (e.g., to receive payment account numbers, loyalty program identifiers, or the like, depending on the nature of the transaction) when the consumer payment device 110 is presented at the terminal by a cardholder.

As will be discussed below in conjunction with FIGS. 2-5, the consumer payment device 110 may be presented at the transaction device 120 for a number of different types of transactions. For example, if a consumer payment device 110 has not yet been enrolled in a merchant loyalty program, the devices may engage in a loyalty program registration transaction (described below in conjunction with FIGS. 2-3). A consumer payment device 110 may also interact with the transaction device 120 to receive a loyalty program script from a remote card issuer or issuer agent, causing a loyalty program identifier to be stored in a memory of the consumer payment device 110 (described below in conjunction with FIG. 4). The consumer payment device 110 may also interact with a transaction device 120 to conduct a loyalty transaction (e.g., where a loyalty program identifier is read from the payment device 110 in conjunction with a purchase transaction) (described below in conjunction with FIG. 5). A consumer payment device 110 may also interact with a transaction device 120 in a normal purchase transaction (e.g., where payment account information is provided by the consumer payment device 110 to purchase goods or services).

The transaction device 120 is in communication with merchant systems 130. For example, in some embodiments, a number of transaction devices 120 are connected to one or more merchant back office systems. The merchant systems 130 (which may be operated by a merchant or a merchant agent) store transaction information and manage and administer loyalty program data. For example, the merchant systems 130 may include a database containing information identifying all participants in a merchant loyalty program, including each participant's loyalty program identifier. This information may be used by the merchant to ensure that participants earn and receive benefits in the loyalty program based on their purchases and transactions conducted at the transaction devices 120. Pursuant to some embodiments of the present invention, merchant systems 130 may be operated to administer and manage loyalty programs in any of a number of different ways, so long as each participant has a loyalty program identifier associated with him or her.

The merchant systems 130 are in communication (either directly or indirectly over a network 140) with payment systems 150. For example, in some embodiments, payment systems 150 include the payment networks operated by MasterCard International Incorporated, the assignee hereof. Payment systems 150 are further in communication with one or more issuer systems 160. Merchant systems 130, payment systems 150 and issuer systems 160 interact to support a number of different types of transactions involving embodiments of the present invention. For example, in loyalty program registration transactions (such as those discussed below in conjunction with FIGS. 2-3), merchant systems 130 forward loyalty program enrollment data to issuers so that the issuer systems 160 can generate loyalty scripts for later installation on consumer payment devices 110. As another example, merchant systems 130 may forward transaction information involving a consumer payment device 110 to the issuer systems 160 during online authorization transactions and the issuer systems 160 may transmit loyalty scripts for delivery to the consumer payment device 110 (as described below in conjunction with FIG. 4) to allow a payment device 110 to store a loyalty program identifier. As another example, merchant systems 130 may interact with the payment systems 150 and issuer systems 160 in normal payment device transactions to authorize, clear and settle payment card transactions.

Although single ones of devices 110, 120, 130, 150 and 160 are shown in FIG. 1, any number of such devices and networks may be included in the system 100. Similarly, any number of the other devices described herein may be included in the system 100 according to embodiments of the present invention. Those skilled in the art will appreciate that a large number of consumer payment devices 110 may participate in systems of the present invention. Further, each consumer payment device 110 may conduct transactions at a large number of different transaction devices 120 with a large number of different merchants.

FIG. 2 is a flow chart that illustrates a process 200 that may be performed by the system 100 of FIG. 1 in connection with the enrollment of a consumer in a loyalty program of a merchant. In particular, process 200 shows process steps that allow a consumer to enroll in a loyalty program, and also to have the loyalty program information stored on his or her payment device.

Process 200 begins at 202 where enrollment data and an associated consumer payment device identifier is received. In some embodiments, this information is obtained at merchant systems 130. The information may be generated at a merchant location when a consumer enrolls in a loyalty program of the merchant. As will be discussed further below, the consumer may enroll in a loyalty program during a point of sale transaction at the merchant or by registering at a registration kiosk or customer service terminal. When the customer enrolls, the customer's payment card information is read and the customer provides enrollment data as required by the merchant's specific loyalty program. For example, some merchants may require that loyalty program participants provide their name, address and telephone number or other contact information. Some merchants may require additional enrollment information such as, for example, shopping preferences or the like.

Merchant systems 130 assign a loyalty program identifier to each participant. The loyalty program identifier is used to uniquely identify each loyalty program participant so that each participant may be credited for their transactions pursuant to the terms of the loyalty program. Each loyalty program identifier is associated with the customer's enrollment data and payment device identifier.

At 204, the enrollment data, the loyalty program identifier (and any other relevant loyalty program data, such as, for example, information identifying the merchant and the specific merchant loyalty program) and the customer's payment device identifier (such as the payment account number or “PAN” which is read from the customer's payment device) are transmitted to the issuer of the payment device (or to a designated agent of the issuer). For example, this information may be transmitted in a batch process on a regular basis (e.g., daily) so that enrollment information for all consumers who enrolled in the merchant's loyalty program in a given period is transmitted in a batch file to the issuer (or issuer agent) for further processing.

The issuer or issuer agent uses this information to create a script, or code applet, that can be loaded onto the consumer's payment device. Loading of the script onto the consumer's payment device causes a data record to be created in a memory of the payment device which includes the consumer's loyalty program identifier and other related loyalty information. Pursuant to some embodiments, the script is loaded at 206 during a subsequent online transaction involving the consumer's payment device. For example, in embodiments in which the consumer's payment device is compliant with the EMV standards, the script may be loaded the next time the consumer's payment device is presented in a transaction (at any transaction terminal, at any retailer) that requires on-line authentication of the transaction. When the on-line authentication is performed, the issuer (or issuer agent) responds to the on-line authentication request with an authentication response, and also with delivery of the script. The script is delivered to the consumer's payment device, and the consumer's payment device executes the script, thereby causing the loyalty program identifier to be stored in a memory of the payment device. Once the loyalty program identifier is stored in the memory of the payment device, it is available to be retrieved during any transaction conducted using the payment device at the merchant.

In this manner, embodiments allow consumers to easily register to participate in merchant loyalty programs. The merchant is able to assign a loyalty program identifier to each participant, and have the loyalty program identifier installed in a memory of the consumer's payment device. The consumer does not need to carry a separate loyalty card, but instead, can participate in a number of loyalty programs using their consumer payment device.

By way of example only, FIG. 2 is a flow chart that illustrates a method that may be performed according to some embodiments. The flow charts in FIG. 2 and the other figures described herein do not imply a fixed order to the steps, and embodiments of the present invention can be practiced in any order that is practicable. Moreover, the methods may be performed by any of the devices described herein.

Consumers may register to participate in merchant loyalty programs in a number of different ways. For example, in some embodiments, consumers may register at a registration terminal or kiosk at a merchant location. Such an embodiment will now be described by reference to FIG. 3A, where a registration process 300 is shown.

Registration process 300 begins at 302 where a customer presents their payment device at a registration terminal or kiosk. The registration terminal or kiosk may be located at a merchant location, or, in some embodiments, may be available as a merchant Website over the Internet. Processing at 302 includes presenting the payment device to a reader, allowing the reader and payment device to communicate. The reader may be a contact or contactless reader.

Processing continues at 304 where the reader and payment device interact to authenticate the device and verify the cardholders In embodiments where the payment device is an EMV-compliant payment device, interaction at 304 is performed in accordance with the EMV standards.

Once the device has been authenticated and the cardholder has been verified, processing continues at 306, where the terminal determines whether the cardholder is a current participant in the merchant loyalty scheme. For example, processing at 306 may include the terminal reading data on the payment device to determine if a loyalty program identifier associated with the merchant loyalty program is already in existence on the device. If so, no further enrollment processing is required and the process 300 is complete.

If the cardholder is not a current participant, processing continues at 308 where a determination is made whether the cardholder is eligible to participate in the loyalty program. For example, a merchant loyalty program may have participation rules including a rule that a payment device be a domestic device (i.e., issued for use in the country or region in which the merchant is located). If processing at 308 determines that the payment device (or cardholder) is not eligible for participation in the loyalty program, processing ends.

If the device is eligible for participation, processing continues at 310 where the merchant assigns a loyalty program identifier to the customer. The loyalty program identifier may be generated or selected from a set of available identifiers so that the customer is uniquely identified within the merchant's loyalty program. In some embodiments, if the customer is already a participant in the loyalty program (but has not yet loaded the loyalty information on their payment device), an existing loyalty identifier already associated with the customer may be selected.

Processing continues at 312 where the terminal prompts the customer to enter enrollment information. Different information may be required by different merchants. For example, a merchant may require that program participants provide their full name, address and contact information. A merchant may also require that a participant provide shopping preferences or other demographic information.

Processing continues at 314 where the enrollment information, the payment account information (read from the payment device), and the assigned loyalty program identifier are entered into an enrollment file. The enrollment file is then processed as shown in FIG. 4 (discussed further below) to cause a script to be created for delivery to, and installation on, the customer's payment device.

In some embodiments, upon completion of process 300, a receipt or ticket may be printed for the customer confirming the enrollment in the loyalty program. The receipt or ticket may be used as a temporary loyalty card until the loyalty program identifier is stored in the customer's payment device. Upon completion of the process 300, the customer is enrolled in the loyalty program and may begin to enjoy the benefits of participation in the program—however, the loyalty program identifier has not yet been stored in the customer's payment device.

Reference is now made to FIG. 3B, where a further embodiment of the enrollment process is shown. In the embodiment of FIG. 3B, a process 350 is performed at a merchant point of sale terminal. For example, process 350 may be used during a customer purchase transaction, allowing the customer to easily register for participation in a merchant loyalty program at a point of sale terminal.

A number of the steps of process 350 are similar to those of the process 300 of FIG. 3A, however, several additional steps are provided. For example, in the process 350, the primary transaction may be processed prior to obtaining enrollment information. That is, if the customer presents their payment device to purchase items at a merchant point of sale terminal, processes 352-356 may first be performed as normal in a purchase transaction. Once the primary purchase transaction is complete, processing continues at 358 where a determination is made whether the customer (or more particularly, the customer's payment device) is registered to participate in the merchant's loyalty program. For example, processing at 358 includes reading data stored in the payment device to determine the presence or absence of a loyalty program identifier. If a loyalty program identifier exists, processing continues at 359 where the loyalty program rules are applied and the transaction details are used to award points or other loyalty benefits pursuant to the merchant's loyalty program.

If, however, processing at 358 indicates that the payment device does not have a loyalty program identifier stored thereon, processing continues at 360 where a determination is made whether the device is eligible to participate (as discussed with FIG. 3A above). If the device is not eligible, processing terminates. If the device is eligible, processing continues at 362 where the customer is prompted (either by the point of sale device or a cashier or other attendant) to indicate whether they wish to join the loyalty program. If the customer declines, processing terminates.

If the customer assents, processing continues at 364-368 and customer information is collected, a loyalty program identifier is assigned, and the enrollment file is updated (as discussed above in conjunction with FIG. 3A). As with processing at FIG. 3A, the customer may be provided with a receipt showing the loyalty program identifier.

In this manner, embodiments allow customers to conveniently enroll in loyalty programs during normal purchase transactions. Merchants are able to acquire more participation in their programs, and both customers and merchants enjoy improved registration convenience and efficiency.

Reference is now made to FIG. 4, where a flow diagram depicts one embodiment of a process 400 for loading a script including a loyalty payment identifier on a consumer payment device. Process 400 may be performed on a regular basis or whenever a merchant has provided a new or updated enrollment file (e.g., as described in FIGS. 3A and 3B).

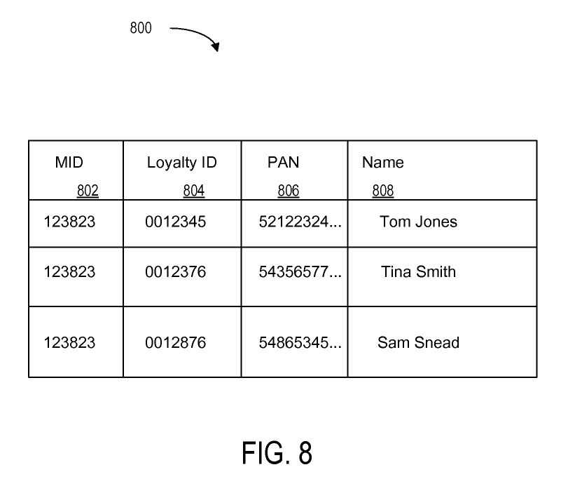

Process 400 begins at 402 where the enrollment file is transmitted to an issuer (and/or an issuer agent) for processing. The enrollment file may be created or updated as discussed above in conjunction with FIGS. 3A and 3B and may be provided to the issuer or issuer agent via a network such as a payment network. An example of an enrollment file is shown in FIG. 8, discussed below.

Each issuer, or issuer agent, processes the records from the enrollment file that relate to customers holding payment cards issued by the issuer. In embodiments in which the payment devices are issued pursuant to the EMV standards, the issuer of a payment device is able to provide command scripts that are to be delivered to the payment device. Only the issuer (or an agent of an issuer) of a payment device may create such scripts (as creation of the scripts involves signing the script with a cryptogram that can be deciphered by the payment device and that can only be generated by the issuer or an issuer agent). Processing at 404 includes creating such a command script. Pursuant to some embodiments, the command script created at 404 includes commands that, when executed by the payment device, cause loyalty data to be written to a non-volatile memory portion of the IC in the payment device. For example, the script will cause the storage of the customer's assigned loyalty program identifier in a memory of the customer's payment device. In some embodiments, the command script may also cause the payment device to store certain loyalty profile data in the payment device. Other data elements may be defined by each merchant pursuant to their loyalty programs.

Once the script has been created for a particular customer record in the enrollment file, processing continues at 406 where the issuer, or the issuer agent, awaits the next online transaction involving the customer's payment device. For example, for payment devices configured pursuant to the EMV standards, only certain payment device transactions require online processing (other transactions can be authorized and completed by simple interaction between the payment device and a terminal). Transactions requiring online processing cause an authorization request cryptogram data packet to be created by the payment device, transmitted to a point of sale device, and then routed through the payment networks to the payment device issuer (or agent) for authorization.

Pursuant to some embodiments, when a command script (created at 404) has been created, it is delivered to the payment device in the authorization response data packet that is responsive to an online authorization request cryptogram data packet. Delivery of the command script to the payment device causes the payment device to verify the authenticity of the script (by checking the cryptogram used to sign the command script). If the script is authentic, the IC of the payment device runs the script, causing data to be written to a memory of the IC. In particular, when the loyalty script is run, it causes at least a loyalty payment identifier to be written to memory. Other information, including profile data or the like, may also be written to memory. Once the script has been processed by the IC of the payment device, the payment device is able to identify the customer as a participant in loyalty programs of the merchant.

The process 400 may be performed multiple times for each payment device so that multiple loyalty program identifiers are stored in a memory of an IC of a single payment device. The result is a payment device that can be used to identify a customer as a participant in multiple merchant loyalty programs, eliminating the need for the customer to carry separate loyalty cards for each of the programs.

Reference is now made to FIG. 5, where a process 500 depicts steps associated with a customer using a payment device to conduct a purchase transaction at a merchant location, where the customer is a member of the merchant's loyalty program, and the payment device has executed the command script as described in FIG. 4 above.

Processing begins at 502, where the customer presents their payment device at a point of sale terminal to make a purchase. At 504, the terminal and the payment device interact to authenticate the payment device, and to verify the cardholders At 506 the terminal causes the payment to be authorized (either offline or online, depending on the nature of the transaction). At 508, the terminal determines (based on information read at 504 or at 508) that the payment device includes a loyalty program identifier associated with the merchant's loyalty program, and causes transaction information to be appended with the loyalty program identifier for future processing pursuant to the merchant loyalty program rules.

Reference is now made to FIG. 6 where a block diagram of an IC chip 600 that may be used in a payment device (such as the payment device shown in FIG. 1 as item 110 above). As depicted, IC chip 600 includes I/O 602 in communication with a processor 604, a non volatile memory 606 and a random access memory (RAM) 608. The I/O 602 may allow the IC chip 600 to communicate via contactless communication (e.g., using radio frequency communication) or via contact communication. Pursuant to some embodiments, the I/O 602 is configured to comply with the requirements of the EMV payment standards, allowing the IC card 600 to communicate with a wide variety of different terminals.

The IC card 600 also includes one or more processors 604. In some embodiments, the IC card 600 may also include other types of control logic, timers, and other I/O ports. The IC card 600 also includes a non-volatile memory 606 which stores transaction card data (including, for example, a primary account number or “PAN” associated with the payment device). The non-volatile memory 606 further stores an operating system of the IC card 600. The operating system, for example, loads and executes applications and scripts and provides file management and other IC card 600 services allowing the IC card 600 to interact with terminals, issuers, and the like. One operating system that may be used to control the IC card 600 is the MULTOS® operating system. Other operating systems may also be used, including, for example, the JAVA CARD operating system.

Pursuant to some embodiments, the processor 604 is capable of receiving a command script created by an issuer (or agent) and executing the script commands. In particular, the processor 604 is capable of executing one or more loyalty command scripts to cause loyalty program identifiers to be stored in the non-volatile memory 606. As a specific example, again for IC cards implemented using the EMV standard, each IC card could store 5, 10 or more loyalty IDs in memory. The loyalty program information may be stored in files identified with file identifiers (or “SFI”) in the range 1-10. For each loyalty program that a cardholder participates in, the EMV file structure may store both a retailer ID and a loyalty program ID. As new programs are enrolled in, new file identifiers may be created. In some embodiments, each loyalty program will also include one or more specific tags to ensure proper storage of payment cardholder profile and other information. All of this information is stored in the non-volatile memory of the IC card 600 upon execution of the command script delivered from the issuer (or issuer agent).

The IC chip 600 may be mounted on a plastic substrate and formed in the shape of a traditional credit card (e.g., in compliance with ISO Standard 7816 and related standards). The IC chip 600 may also be mounted or deployed in other form factors as well. For example, the IC chip 600 may be placed in a cellular phone handset, a key fob, a personal digital assistant (PDA), or the like.

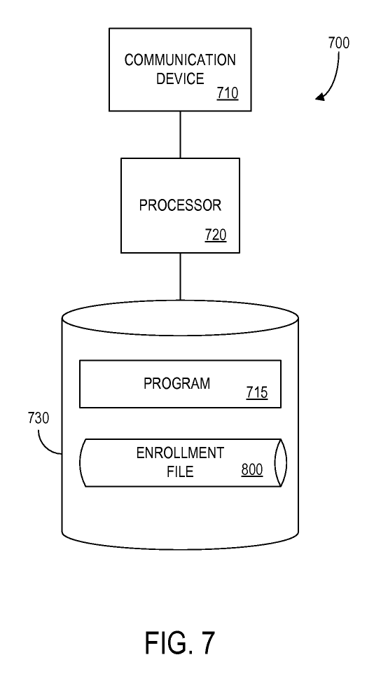

Reference is now made to FIG. 7 which is a block diagram of a merchant device 700, which may be used as the merchant systems 130 of FIG. 1, according to some embodiments. In this case, the merchant device 700 includes a communication port 710 to exchange data over a network to facilitate communication with, for example, other devices (such as point of sale devices or transaction devices 120, payment systems 150 and issuer systems 160). Note that numerous ports 710 may be provided (to allow for simultaneous communication with a number of other devices) and may be preferably configured with hardware suitable to physically interface with desired external devices and/or network connections. For example, the communication port 710 may comprise an Ethernet connection to a local area network through which the merchant device 700 may receive and transmit information over the Internet and/or over private or proprietary networks.

In addition, the merchant device 700 includes a processor 720 and a memory 730 which stores programs and data including, for example, loyalty program software 715 and an enrollment file 800. The processor 720 operates to execute processor-executable process steps so as to control the merchant device 700 to provide desired functionality. For example, the processor 720 may execute loyalty program software 715 to control the enrollment processes described above, to create and update the enrollment file based on new enrollment data, to transmit the enrollment file to the appropriate issuers (or agents), and to track and administer the merchant's loyalty program.

As shown in FIG. 7, the merchant device 700 also stores an enrollment file 800. An example of the types of data that may be stored in the enrollment file 800 are shown in FIG. 8. Note that the illustrations and accompanying description of the enrollment file 800 is exemplary, and any number of other database arrangements could be employed besides those suggested by the figures. For example, as will be understood by those skilled in the art, the schematic illustrations shown herein and the following descriptions of the exemplary entries are merely examples of arrangements for stored representations of information. Any number of other arrangements may be employed besides that suggested by the tables shown. Similarly, the illustrated entries of the database represent exemplary information only.

In a practical embodiment, the number of entries in the enrollment file (and other databases used to implement the present invention) may be in the thousands, or even in the millions. Moreover, for convenience of presentation, the illustrative enrollment file is shown as having only four fields. However, in practice additional fields may be present, such as other fields for additional consumer contact information, account preferences, etc. Also, note that the information stored in the enrollment file 800 may be stored by (or at) and/or accessed by any number of different parties or locations (e.g., by an issuer, an account processor, and/or any other agent or party).

FIG. 8 is a portion of a tabular representation of an enrollment file 800 that may be stored at the apparatus 700 according to an embodiment of the present invention. The table includes entries identifying data associated with a consumers who have enrolled in the merchant's loyalty program pursuant to some embodiments. The table also defines fields 802, 804, 806, 808 for each of the entries. The fields specify: a merchant identifier 802, a loyalty program identifier 804, a primary account number 806 and a customer name 808. The information in the enrollment file 800 may be created and updated, for example, based on information received from transaction devices as a result of a payment cardholder registering to participate in a loyalty program of the merchant (e.g., the enrollment file may be created as result of the processes of FIGS. 3A and 3B). The information in the enrollment file 800 may be transmitted to a number of issuers (e.g., based on the BIN component of the PAN 806) so that the issuers (or their agents) can create a command script to cause the loyalty payment identifier 804 to be stored on the payment device of each enrolled participant.

Although the present invention has been described in connection with specific exemplary embodiments, it should be understood that various changes, substitutions, and alterations apparent to those skilled in the art can be made to the disclosed embodiments without departing from the spirit and scope of the invention as set forth in the appended claims.

What is claimed is:

1. A method, comprising:
receiving, from a consumer associated with a payment device, loyalty program enrollment information and a payment device identifier, said loyalty program enrollment information including a loyalty program identifier;
providing said loyalty program enrollment information and said payment device identifier to at least one of an issuer of said payment device and an agent of said issuer; and
causing said loyalty program identifier to be stored in a memory of said payment device.

2. The method of claim 1, wherein said payment device comprises an integrated circuit card and said memory is a memory of said integrated circuit card.

3. The method of claim 1, wherein said causing said loyalty program identifier to be stored includes:
receiving, at one of said issuer and said agent of said issuer, an online authorization request associated with said payment device; and
transmitting a script to said payment device, said script executing on said payment device and causing said loyalty program identifier to be stored in said memory of said payment device.

4. The method of claim 1, wherein said memory of said payment device stores a plurality of said loyalty program identifiers, each loyalty program identifier associated with a separate loyalty program.

5. The method of claim 2, wherein said integrated circuit card is configured to operate in compliance with the EMV chip card specifications.

6. The method of claim 1, wherein said loyalty program information and associated payment device identifier is received from at least one of a point of sale terminal and a registration terminal.

7. The method of claim 1, wherein said loyalty program information and associated payment device identifier is received from a point of sale terminal during a transaction involving said payment device.

8. A method for operating a merchant terminal to enroll a consumer in a loyalty program, the method comprising:
reading, at a merchant terminal, payment device information from a payment device, said payment device information including a primary account number associated with said payment device;
determining, from said payment device information, that said payment device is eligible to participate in a merchant loyalty program;
receiving, from said consumer associated with said payment device, enrollment information;
assigning a loyalty program identifier to said primary account number;
updating a merchant loyalty program enrollment file with said primary account number, said loyalty program identifier, and said enrollment information; and
forwarding said updated merchant loyalty program enrollment file to an issuer processor associated with an issuer of said primary account number.

9. The method of claim 8, wherein said merchant terminal is one of a point of sale terminal and a registration terminal.

10. The method of claim 8, wherein said forwarding said updated merchant loyalty program enrollment file causes said issuer processor to generate a script for loading onto said payment device.

11. The method of claim 10, wherein said script causes said loyalty program identifier to be written into a memory of said payment device.

12. The method of claim 11, wherein said memory of said payment device is configured to store a plurality of different loyalty program identifiers.

13. An apparatus, comprising:
a processor; and
a storage device in communication with said processor and storing instructions adapted to be executed by said processor to:
receive, from a consumer associated with a payment device, loyalty program enrollment information and a payment device identifier, said loyalty program enrollment information including a loyalty program identifier;
provide said loyalty program enrollment information and said payment device identifier to at least one of an issuer of said payment device and an agent of said issuer; and
cause said loyalty program identifier to be stored in a memory of said payment device.

14. The apparatus of claim 13, wherein said storage device further stores a loyalty program database including a plurality of loyalty program identifiers.

15. The apparatus of claim 13, further comprising:
a communication device coupled to said processor and adapted to communicate with at least one of: (i) a point of sale device, and (ii) a registration terminal.

16. An apparatus, comprising:
a processor; and
a storage device in communication with said processor and storing instructions adapted to be executed by said processor to:
read payment device information from a payment device, said payment device information including a primary account number associated with said payment device;
determine, from said payment device information, that said payment device is eligible to participate in a merchant loyalty program;
receive, from said consumer associated with said payment device, enrollment information;
assign a loyalty program identifier to said primary account number;
update a merchant loyalty program enrollment file with said primary account number, said loyalty program identifier, and said enrollment information; and
forward said updated merchant loyalty program enrollment file to an issuer processor associated with an issuer of said primary account number.

17. A computer-readable medium storing instructions adapted to be executed by a processor to perform a method of offering credit products to consumers, said method comprising:
receiving, from a consumer associated with a payment device, loyalty program enrollment information and a payment device identifier, said loyalty program enrollment information including a loyalty program identifier;
providing said loyalty program enrollment information and said payment device identifier to at least one of an issuer of said payment device and an agent of said issuer; and
causing said loyalty program identifier to be stored in a memory of said payment device.
